(19) United States
(12) Patent Application Publication
(10) Pub. No.: US 2011/0177264 A1
(43) Pub. Date: Jul. 21, 2011

(54) INKJET RECORDING MEDIUM AND METHOD OF MANUFACTURING THE SAME

(75) Inventor: Hirokazu Kawai, Fujinomiya-shi (JP)

(73) Assignee: FUJIFILM CORPORATION, Minato-ku, Tokyo (JP)

(21) Appl. No.: 13/119,680

(22) PCT Filed: Sep. 18, 2009
(86) PCT No.: PCT/JP2009/066849

§ 371 Date: Mar. 17, 2011

(30) Foreign Application Priority Data
Sep. 26, 2008 (JP) 2008-247615

(51) Int. Cl. B41M 5/50; B41M 5/00

(52) U.S. Cl. 428/32.32; 428/32.1; 428/32.34; 428/32.31

(57) ABSTRACT

A web (12) has resin coat layers (46, 47) on both surfaces of a base material (45), and one of the resin coat layer (47) is covered with an ink receiving layer (48). The web (12) is slit into narrow recording papers (14) by a slitter (13). This slitter (13) includes an upper rotary blade (21) having a sharp cutting edge, and a lower rotary blade (19) having a support (61) for the ink receiving layer (48) . After the slitting with the slitter (13), a cut face has a cross section in which one of the base material (45), the resin coat layer (47) and the ink receiving layer (47) projects outward relative to the resin coat layer (46).

### TECHNICAL FIELD

The present invention relates to an inkjet recording medium and a method of manufacturing the same.

### BACKGROUND ART

An image recording paper is a type of inkjet recording media. The image recording paper, or so-called a gloss RC paper, has resin coat (synthetic resin coat) layers of polyethylene on both surfaces of a paper as a base material, and an ink receiving layer that covers one of the resin coat layers and absorbs inks. The ink receiving layer is composed mainly of silica fine particles and resin binders for binding the particles.

The inkjet recording papers are broadly classified into sheet papers and roll papers. The sheet paper is obtained by firstly slitting a long and wide web into narrow strips using a slitter, and then transecting the narrow paper strips into certain length sheets using a cutting machine (see, for example, Japanese Patent Laid-open Publication No. 2005-14106). The roll paper is, by contrast, obtained by winding the narrow paper strip around a core (see, for example, Japanese Patent Laid-open Publication No. 09-100050).

By the way, there is a type of inkjet printer for borderless printing to form an image over the entire surface of a recording paper. In the borderless printing, inks are ejected to run over the side edges extending parallel to a transport direction in the printer. When the aforesaid image recording papers are used for the borderless printing, however, the interior of the printer gets soiled with ink, and so does a recording paper as it is placed on the previously recorded paper.

In analyzing conventional inkjet recording paper roll and sheet, as shown in FIG. 10, the side edge has a cut face 70, or a cross section in which a resin coat layer 46 projects outward relative to the other resin coat layer 47 and an ink receiving layer 48. This cut face 70 is not smooth, though it is slit by a slitter, and reveals poor cutting quality.

In the inkjet printer, this type of recording paper is transported with the ink receiving layer 48 facing upward (shown upside down in FIG. 10). Accordingly, the ejected inks easily land on the projecting end of the resin coat layer 46, and soil the interior of the printer or the next recording paper.

Additionally, the ink receiving layer 48 fail to provide adequate strength in some cases, and may crack or separate as it dries.

In view of the forgoing, it is a main object of the present invention to provide an inkjet recording medium and the method of manufacturing the same for preventing ink stains on a printer interior and other recording media.

Another object of the present invention is to provide an inkjet recording medium and the method of manufacturing the same for achieving acceptable cutting quality.

Yet another object of the present invention is to provide an inkjet recording medium and the method of manufacturing the same for preventing crack and delamination of the ink receiving layer.

### DISCLOSURE OF INVENTION

In order to achieve the above and other objects, the inkjet recording medium according to the present invention includes a base material, first and second resin coat layers on both surfaces of the base material, and an ink receiving layer on the second resin coat layer. This inkjet recording medium further includes end faces slit by a slitter. Each of the end faces has a cross section in which at least one of the second resin coat layer and the ink receiving layer or the base material projects outward relative to the first resin coat layer.

These end faces are side edges extending parallel to a transport direction in printing. The recording medium may includes a sheet paper in predetermined rectangular dimension or a roll paper obtained by winding a narrow paper strip into a roll.

Preferably, the ink receiving layer contains water soluble resin and fine particles, and a ratio of weight of the fine particles to the water soluble resin is preferably at least 1.5 and up to 10.

The ink receiving layer preferably has a thickness of 10-50 micrometers.

Additionally, the ink receiving layer is preferably a porous layer having a median pore diameter of 0.005-0.030 micrometers.

A method of manufacturing an inkjet recording medium according to the present invention includes a web producing step and a web slitting step. In the web producing step, first and second resin coat layer are applied on both surfaces of a base material, and an ink receiving layer is then applied on the second resin coat layer. In the web slitting step, the web transported in one direction is slit by a slitter with the ink receiving layer facing downward. This slitter has an upper rotary blade with a sharp cutting edge for press-cutting the web, and a lower rotary blade with a support for the web. The slitter slits the web in such a manner that each end face of the web has a cross section in which at least one of the second resin coat layer and the ink receiving layer or the base material projects outward relative to the first resin coat layer.

Preferably added is the step of transecting the web into predetermined length sheets.

The upper rotary bale has a blade angle of preferably 30 degrees, and the lower rotary blade has a blade angle of preferably 90 degrees. The blade angle of the upper rotary blade may be 30 degrees when the blade angle of the lower rotary blade is 30 degrees. Furthermore, the blade angle of the upper rotary blade may be 60 degrees, and the blade angle of the lower rotary blade may be 90 degrees.

According to the present invention, the inkjet recording medium has end surfaces in which the first resin coat layer recedes behind at least one of the second resin coat and the ink receiving layer or the base material. The ejected inks do not land on the first resin coat layer in the borderless printing, and the printer interior and the other recording media can be protected from ink stains.

Additionally, in the present invention, the base material is slit to have a boundary that bulges outward in a triangle shape, and thus the cut surface is fine and smooth.

Also, the ink receiving layer is adjusted to have given ratio of components, thickness and micropore diameter, and is thus prevented from cracking and delaminating.

### BRIEF DESCRIPTION OF DRAWINGS

FIG. 1 is a schematic structure view of an inkjet recording paper manufacturing apparatus;

FIG. 2 is a cross sectional view of a web;

FIG. 3 is an elevation view, partially broken away, of a slitter;

FIG. 4 is a cross sectional view of the slitter;

FIG. 5 is an enlarged, fragmentary axial cross sectional view of the slitter;

FIG. 6 is a cross sectional view showing a cut surface of a recording paper according to the present invention;

FIG. 7 is a cross sectional view showing another cut surface having a slope on a resin coat layer on the reverse side of an ink receiving layer;

FIG. 8 is a cross sectional view showing yet another cut surface bulging in the middle;

FIG. 9 is a cross sectional view showing still another cut surface partially projecting on the ink receiving layer side; and

FIG. 10 is a cross sectional view showing a cut surface of a conventional recording paper.

### BEST MODE FOR CARRYING OUT THE INVENTION

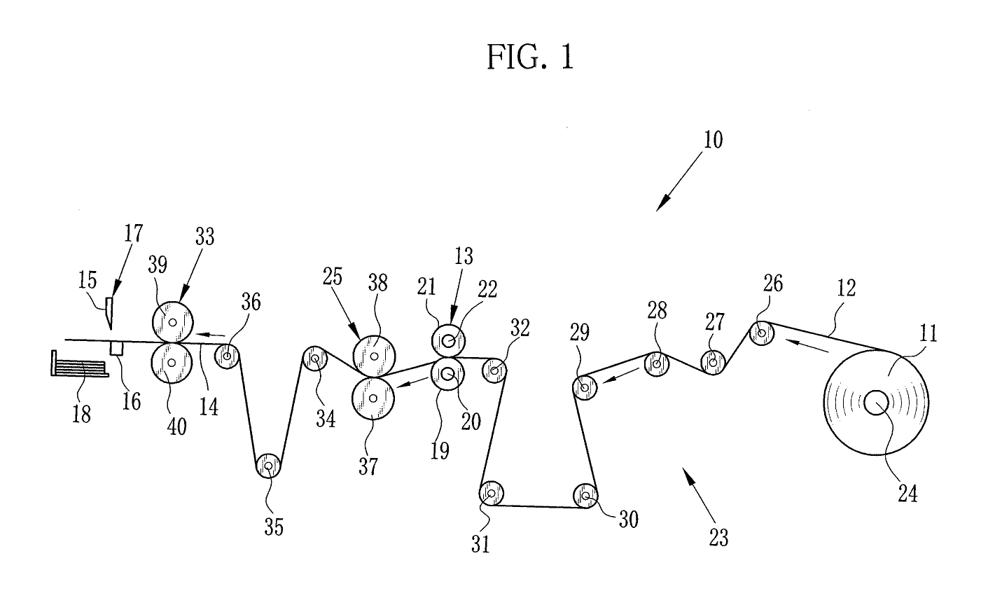

Referring to FIG. 1, a manufacturing apparatus 10 draws a relatively wide web 12 from a web roll 11, and transports the web 12 in a certain direction. The web 12 is slit into a plurality of narrow recording papers 14 using a plurality of slitters 13 arranged at regular intervals along a width direction of the web 12. These recording papers 14 are kept transported in the same direction, and cut into recording sheets 18 in certain length using a cutting machine 17 having a movable upper blade 15 and a stationary lower blade 16.

Each of the slitters 13 includes a discoid lower rotary blade 19, a lower blade motor 20 for rotating the lower rotary blade 19, a discoid upper rotary blade 21 facing the lower rotary blade 19, and an upper blade motor 22 for rotating the upper rotary blade 21. The manufacturing apparatus 10 is also equipped with a transport mechanism 23 for transporting the web 12 and the recording papers 14.

This transport mechanism 23 has a roll holding shaft 24, a pullout roller 25, a first set of pass rollers 26 to 32, a supply roller 33, and a second set of pass rollers 34 to 36. The roll holding shaft 24 holds the web roll 11 in a rotatable manner. The pullout roller 25 draws the web 12 from the web roll 11 on the roll holding shaft 24. The pass rollers 26 to 32 are located along a transport path of the web 12 between the roll holding shaft 24 and the slitters 13, so as to route the web 12 and keep proper tension thereof. The supply roller 33 delivers the recording papers 14 being slit by the slitters 13 to the cutting machine 17. The pass rollers 34 to 36 are located between the pullout roller 25 and the supply roller 33, so as to route the recording papers 14 and keep proper tension thereof.

The pullout roller 25 includes a plurality of roller pairs arranged at regular intervals in a crosswise direction of the transport path. Each roller pair has two rollers 37, 38 that pinch the recording paper 14 from above and below. Rotation of these rollers 37, 38 leads to draw the web 12 from the web roll 11. Similarly, the supply roller 33 includes a plurality of roller pairs arranged at regular intervals in a crosswise direction of the transport path. Each roller pair has two rollers 39, 40, which rotate intermittently to feed a given length of the recording paper 14 in the cutting machine 17. The cutting machine 17 transects the recording papers 14 to produce the recording sheets 18 in certain length.

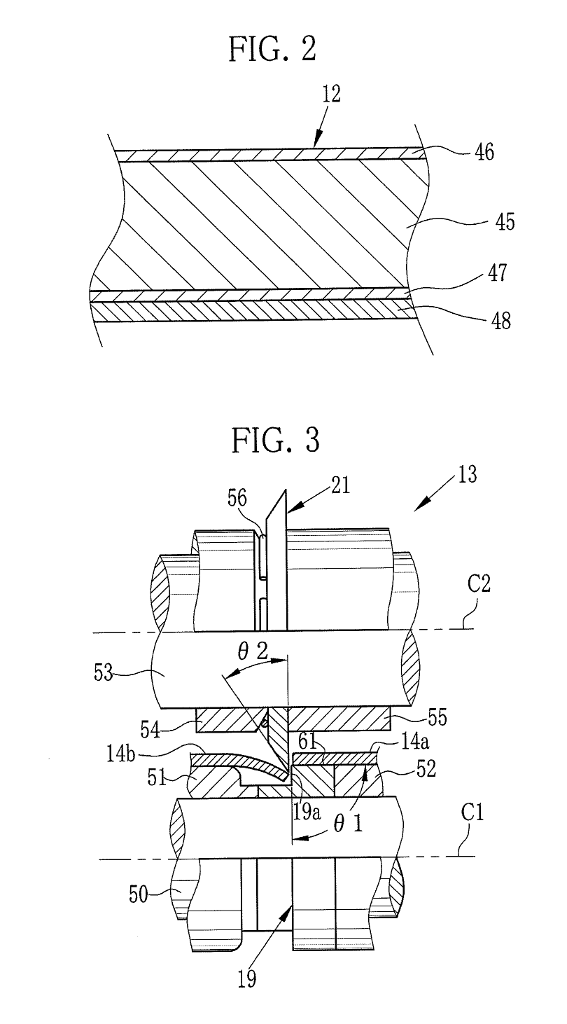

As shown in FIG. 2, the web 12 includes a base material (support) 45, first and second resin coat layers 46, 47 on both surfaces of the base material 45, and an ink receiving layer 48 over the second resin coat layer 47. The base material 45 may be a synthetic paper, a natural paper or a film. The ink receiving layer 48 is composed of silica-based fine particles and resin binders of polyvinyl alcohol or the like for binding the fine particles. This ink receiving layer 48 is harder, but more fragile, than the base material 45. The ink receiving layer 48 faces downward as the web 12 is transported on the transport mechanism 23.

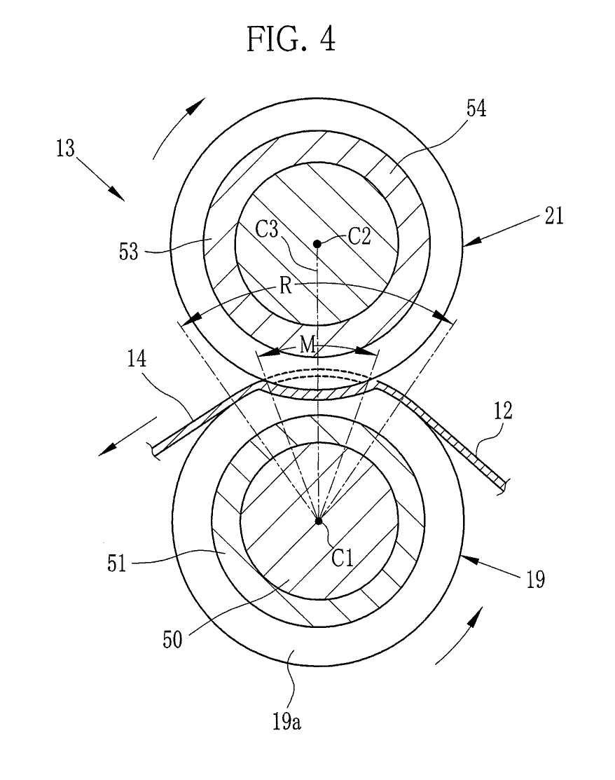

As shown in FIG. 3 and FIG. 4, the lower and upper rotary blades 19, 21 are arranged in such a manner that an axis of rotation C1 of the lower rotary blade 19 extends parallel to an axis of rotation C2 of the upper rotary blade 21, and that the lower and upper rotary blades 19, 21 overlap partly on a vertical line C3 connecting the axes C1, C2. The upper rotary blade 21 has a blade angle (cutting edge angle) θ2 that is smaller than a blade angle (approximately 90 degrees) of the lower rotary blade 19.

The lower rotary blade 19 fits onto a lower blade shaft 50 coupled to a rotary shaft of the lower blade motor 20. Located between lower blade spacers 51, 52 on the lower blade shaft 50, the lower rotary blade 19 rotates integrally with the lower blade shaft 50.

The upper rotary blade 21 fits onto an upper blade shaft 53 coupled to a rotary shaft of the upper blade motor 22. Located between upper blade spacers 54, 55 on the upper blade shaft 53, the upper rotary blade 21 rotates integrally with the upper blade shaft 53. Between the upper blade spacer 54 and the upper rotary blade 21, there is provided a spring 56 for pushing the upper rotary blade 21 to the lower rotary blade 19. Having the shape of an incomplete ring, or namely a C shape, the spring 56 closes within a sloping surface of the upper blade spacer 54 upon the rotation thereof, and pushes the upper rotary blade 21 to the lower rotary blade 19.

As better shown in FIG. 4, the web 12 bulges outward to the upper rotary blade 21 with the ink receiving layer 48 following the circumference of the lower rotary blade 19, as it passes between the lower and upper rotary blades 19, 21 while. The area of contact between the web 12 and the lower rotary blade 19, or a wrap area R is longer on both ends in the transport direction than a contacting area M of the lower and upper rotary blades 19, 21. The lower and upper rotary blades 19, 21 rotate in the transport direction of the web 12.

Accordingly, the web 12 is cleaved or sheared apart, from the ink receiving layer 48 to the first resin coat layer 46, in the contacting area M.

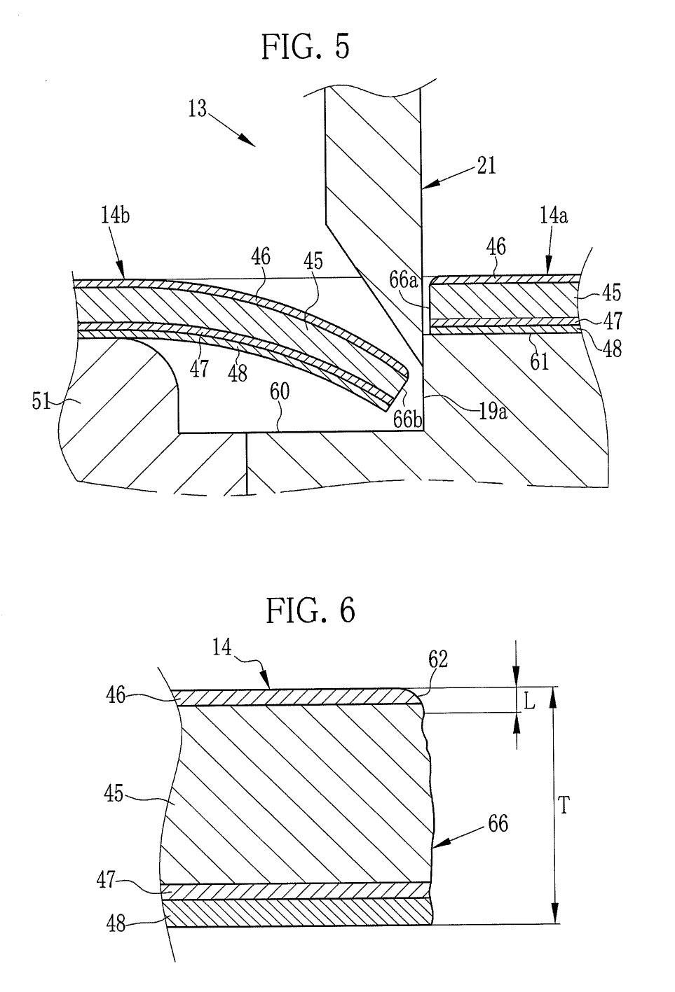

As described, the relatively wide web 12 is slit into the narrow recording papers 14 with a plurality of slitters 13. In FIG. 3 and FIG. 5, for illustrative purpose, the recording papers 14 after slitting are denoted by numerals 14a, 14b.

As shown in FIG. 5, a cut surface 66a of the recording paper 14a stays on a support 61 of the lower rotary blade 19, and a cut surface 66b of the recording paper 14b hangs down in a recess 60 of the lower rotary blade 19. Accordingly, these cut surfaces 66a, 66b both have a cross section in which the first resin coat layer 46 recedes from the base material 45, the second resin coat layer 47 and the ink receiving layer 48. As shown in FIG. 3, the blade angle θ1 of the lower rotary blade 19 is an angle between a blade surface 19a and the support 61 for the ink receiving layer 48.

FIG. 6 shows an example of a cut surface 66 in which the first resin coat layer 46 has a round edge 62 that makes the first resin coat layer 46 recede from the base material 45, the second resin coat layer 47 and the ink receiving layer 48. In this case, the round edge 62 has a height L in the range of 4 to 45%, or more preferably 8 to 15%, to a thickness T of the recording paper 14. This cut surface 66 constitutes each of lateral sides of the resultant recording sheet 18, and extends parallel to a paper transport direction in the printer.

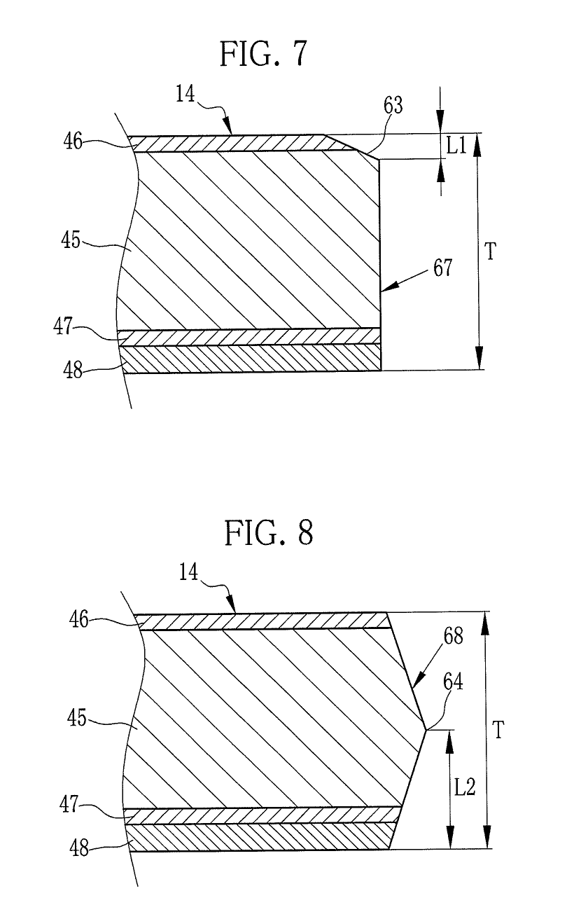

Another example of the cut surface is shown in FIG. 7, where the first resin coat layer 46 has a sloping edge 63 that makes the first resin coat layer 46 recede from the base material 45, the second resin coat layer 47 and the ink receiving layer 48. In this case, the sloping edge 63 has a height L1 in the range of 4 to 45%, or more preferably 8 to 15%, to the thickness T of the recording paper 14.

Yet another example of the cut surface is shown in FIG. 8, where the slitting proceeds toward a middle part 64 of the base material 45 which thus bulges out in the shape of triangle. The inks on the base material 45, if adhering thereto, are absorbed by the base material 45 before soiling the interior of the printer. A height L2, or the length from the ink receiving layer 48 to the apex of the middle part 64, is preferably in the range of 15 to 70%, or more preferably 21 to 60%, to the thickness T of the recording paper 14.

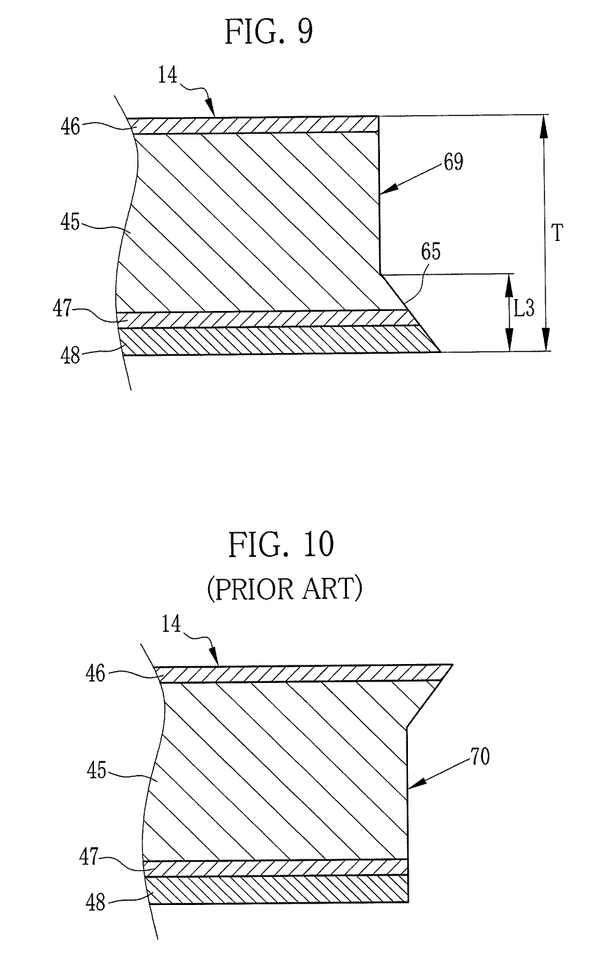

Still another example of the cut surface is shown in FIG. 9, where the slitting proceeds toward the ink receiving layer 48 to form a projecting part 65 on the side of the ink receiving layer 48. The inks adhering to this cut surface are absorbed by both ink receiving layer 48 and the base material 45 before causing ink stains. The projecting part 65 has a height L3 in the range of 25 to 70%, or more preferably 30 to 50%, to the thickness T of the recording paper 14.

Hereafter described are several examples to clarify the relationship between web slitting conditions of the slitter 13 and the qualities of the recording papers 14.

### FIRST EXAMPLE

The web 12 was fed to the slitter 13 with the first resin coat layer 46 facing to the upper rotary blade 21. The blade angle θ1 of the lower rotary blade 19 was 90 degrees, and the blade angle θ2 of the upper rotary blade 21 was 30 degrees. The resultant recording sheet was then set in a printer in such a manner that the side edges, or namely the sides being slit, are parallel to a paper transport direction of the printer.

### SECOND EXAMPLE

The web 12 was fed to the slitter 13 with the first resin coat layer 46 facing to the upper rotary blade 21. The blade angle θ1 of the lower rotary blade 19 was 30 degrees, and the blade angle θ2 of the upper rotary blade 21 was also 30 degrees.

### THIRD EXAMPLE

The web 12 was fed to the slitter 13 with the first resin coat layer 46 facing to the upper rotary blade 21. The blade angle θ1 of the lower rotary blade 19 was 90 degrees, and the blade angle θ2 of the upper rotary blade 21 was 60 degrees.

### FOURTH EXAMPLE

The web 12 was fed to the slitter 13 with the ink receiving layer 48 facing to the upper rotary blade 21. The blade angle θ1 of the lower rotary blade 19 was 90 degrees, and the blade angle θ2 of the upper rotary blade 21 was 30 degrees.

The recording sheet 18 of the first example had the cut surface 66 shown in FIG. 6, or namely, as seen in cross section, the first resin coat layer 46 had the round edge 62, and receded behind the base material 45, the second resin coat layer 47 and the ink receiving layer 48. In some cases, the recording sheet 18 of the first example had the cut surface 69 shown in FIG. 9, or namely, as seen in cross section, the base material 45, the second resin coat layer 47 and the ink receiving layer 48 projected outward relative to the first resin coat layer 46. These recording sheets 18 of the first example did not soil the interior of the printer or other succeeding recording papers, and maintained an acceptable cutting quality as products.

The recording sheets 18 of the second example mostly had the cut surface 66 of FIG. 6, and some had the cut surface 68 shown in FIG. 8, or namely, as seen in cross section, the middle part 64 of the base material 45 projected outward relative to the first resin coat layer 46. These recording sheets 18 of the second example did not soil the interior of the printer or other succeeding recording papers, and maintained an acceptable cutting quality as products.

The recording sheets 18 of the third example had the cut surface 67 shown in FIG. 7, or namely, as seen in cross section, the first resin coat layer 46 had the sloping edge 63, and receded behind the base material 45, the second resin coat layer 47 and the ink receiving layer 48. These recording sheets 18 of the third example did not soil the interior of the printer or other succeeding recording papers, and maintained an acceptable cutting quality as products.

In the fourth example, the web 12 was reversed and fed to the slitter 13 in the state that the first resin coat layer 46 was supported on the support 61 of the lower rotary blade 19. The resultant recording sheet 18 had the cut surface 70 where, as shown in FIG. 10, the first resin coat layer 46 projected outward relative to the base material 45, the second resin coat layer 47 and the ink receiving layer 48. This recording sheet 18 soiled the interior of the printer or other succeeding recording papers, and failed to maintain an acceptable cutting quality as products.

The slitting was performed in an atmosphere with humidity of 40-70%. The slitter 13 was rotated at the speed of 140-300 m/min. The tension on the web 12 was 14-33 kg/m width. The ink receiving layer 48 had the thickness of 30-40 μm, and each of the first and second resin coat layers 46, 47 had the thickness of 20 μm, and the total thickness of the web 12 was 200-350 μm. The cutting quality was nearly unaffected by the change in the rotation speed of the slitter or the change in the thickness of the base material, resin coat layers and the ink receiving layer. This fact implied that the cutting quality was affected, in a sense, by which of the first resin coat layer 46 or the ink receiving layer 48 faced the lower rotary blade 19.

It was therefore concluded that the acceptable cutting quality was maintained by feeding the web 12 to the slitter 13 with the ink receiving layer 48 facing downward to the support 61 of the lower rotary blade 19.

The above examples indicated preferable combination of the blade angles θ1, θ2: 90 degrees for θ1 and 30 degrees for θ2, 30 degrees for both θ1 and θ2, and 90 degrees for θ1 and 60 degrees for θ2. Broadly, the blade angle θ1 may be in the range of preferably 20 to 90 degrees, and more preferably 30 to 90 degrees. The blade angle θ2 may be in the range of preferably 20 to 85 degrees, and more preferably 30 to 60 degrees.

The ink receiving layer of the inkjet recording paper of the invention includes, at least, a water soluble resin, cross-linking agent, fine particles, mordant and additives. For example, the ink receiving layer is formed with a coating liquid which includes a “cation modified self-emulsifying polymer compound”. The term “cation modified self-emulsifying polymer compound” means a polymer compound from which can be obtained naturally a stable emulsion dispersion in an aqueous medium without the addition of emulsifier or surfactant, or if they are used by only adding a trace amount thereof. Qualitatively, the above “cation modified self-emulsifying polymer compound” represents polymer substances which have a stable emulsifying ability of a concentration of 0.5 mass % or greater in an aqueous dispersal medium at 25.degree. C. This concentration is preferably 1 mass % or greater, and particularly preferably 3 mass % or greater.

More specific examples of the above “cation modified self-emulsifying polymer compound” of the invention are, for example, poly-addition or polycondensation based polymer compounds including cationic groups of primary, secondary or tertiary amine groups, or quaternary ammonium groups.

For the above polymers, vinyl polymerization based polymers can be used, such as polymers obtained by the polymerization of the following vinyl monomers. Examples include: acrylic acid esters and meta acrylic acid esters (as substituents for the ester group are alkyl and allyl groups, for example the following groups can be used, methyl, ethyl, n-propyl, isopropyl, n-butyl, sec-butyl, tert-butyl, hexyl, 2-ethylhexyl, tert-octyl, 2-chloroethyl, cyanoethyl, 2-acetoxyethyl, tetrahydrofurfuryl, 5-hydroxypentyl, cyclohexyl, benzyl, hydroxyethyl, 3-methoxybutyl, 2-(2-methoxyetoxy)ethyl, 2,2,2-tetrafuroroethyl, 1H, 1H, 2H, 2H-perfluorodecyl, phenyl, 2,4,4-tetramethyl phenyl, 4-chlorophenyl);

Vinyl esters, specifically aliphatic carboxylic acid vinyl esters which may have substituents (for example, vinyl acetate, vinyl propionate, vinylbutyrate, vinyl isobutyrate, vinylcaproate, vinylchloroacetate), aromatic carboxylic acid esters which may have substituents (for example benzoic acid vinyl, 4-methyl benzoic acid vinyl, salicylic acid);

Acrylic amides specifically acrylic amides, N-mono substituted acrylic amides, N-di substituted acrylic amides (for substituents there are substitutable groups such as alkyl, aryl, and silyl—for example methyl, n-propyl, isopropyl, n-butyl, tert-butyl, tert-octyl, cyclohexyl, benzyl, hydroxy methyl, alkoxy methyl, phenyl, 2,4,5-tetramethyl phenyl, 4-chlorophenyl, trimethyl silyl groups);

Methacrylic amides, specifically methacrylic amides, N-mono substituted methacrylic amides, N-di substituted methacrylic amides (for substituents there are substitutable groups such as alkyl, aryl, and silyl—for example methyl, n-propyl, isopropyl, n-butyl, tert-butyl, tert-octyl, cyclohexyl, benzyl, hydroxy methyl, alkoxy methyl, phenyl, 2,4,5-tetramethyl phenyl, 4-chlorophenyl, trimethyl silyl groups);

Olefins (for example ethylene, propylene, 1-pentene, vinyl chloride, vinylidene chloride, isoprene, chloroprene, butadiene), styrenes (for example styrene, methylstyrene, isopropylstyrene, methoxystyrene, acetoxystyrene, and chlorostyrene), vinyl ethers (for example methyl vinyl ether, butyl vinyl ether, hexyl vinyl ether, and methoxyethyl vinyl ether).

As the other vinyl monomer, examples include listed crotonate esters, itaconate esters, maleate diesters, fumarate diesters, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethyl phosphate, dipheyl-2-methacryloyloxyethyl phosphate, dibutyl-2-acryloyloxyethyl phosphate, dioctyl-2-methacryloyloxyethyl phosphate and the like.

As the above-mentioned monomer having a cationic group, there are, for example, monomers having a tertiary amino group, such as dialkylaminoethyl methacrylates, dialkylaminoethyl acrylates and the like.

As polyurethanes applicable to the cationic-group-containing polymer, there are, for example, polyurethanes synthesized by the addition polymerization reaction of various combinations of the diol compounds with the diisocyanate compounds.

Examples of the above-mentioned diol compound include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2-methyl-2-propyl-1,3-propanediol, 2,5-dimethyl-2,-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycols (average molecular weight=200, 300, 400, 600, 1000, 1500, 4000), polypropylene glycols (average molecular weight=200, 400, 1000), polyester polyols, 4,4′-dihydroxy-diphenyl-2,2-propane, 4,4′-dihydroxyphenylsulfonic acid, and the like.

As the above-mentioned diisocyanate compound, examples include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylene bis(4-cyclohexyl isocyanate), and the like.

As the cationic group contained in the cationic group-containing polyurethane, there are cationic groups such as primary, secondary and tertiary amines and quaternary ammonium salts. In the self-emulsifying polymer of the invention, it is preferable to use a urethane resin with cationic groups such as tertiary amines or quaternary ammonium salts.

The cationic group-containing polyurethanes can be obtained, for example, by introducing cationic groups such as the above diols at the time of synthesizing the polyurethane. Also, in the case of quaternary ammonium salts, polyurethanes containing tertiary amino groups can be quaternized with a quaternizing agent.

The diol compounds and diisocyanate compounds usable for synthesizing the polyurethane may be used each alone, or may be used in combinations of two or more in various proportions decided depending on the purpose (for example, control of the polymer glass transition temperature (Tg), improving solubility, providing compatibility with a binder, and improving stability of a dispersion).

As the polyester applicable to the cationic-group-containing polymer, there are, for example, polyesters synthesized by polycondensation reactions of various combinations of the diol compounds with the dicarboxylic acid compounds listed below.

As the above-mentioned dicarboxylic acid compounds, there are listed oxalic acid, malonic acid, succinic acid, glutaric acid, dimethylmaleic acid, adipic acid, pimelic acid, .alpha., .alpha.-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethyleneterephthalate)dicarboxylic acid, 1,2-cyclohexanedicarboxylic acid, 1,4-cyclohexanedicarboxylic acid, .omega.-poly(ethyleneoxide)dicarboxylic acid, p-xylylenedicarboxylic acid and the like.

The above-mentioned dicarboxylic acid compound may, when polycondensed with a diol compound, be used in the form of an alkyl ester (for example, dimethyl ester) of a dicarboxylic acid or an acid chloride of a dicarboxylic acid, or be used in the form of an acid anhydride such as maleic anhydride, succinic anhydride and phthalic anhydride.

As the diol compound, the same compounds as the diols exemplified for the above-mentioned polyurethane can be used.

The cationic group-containing polyester can be obtained by synthesis using a dicarboxylic acid compound having a cationic group such as primary, secondary and tertiary amines and quaternary ammonium salts.

The above-mentioned diol compounds, dicarboxylic acids and hydroxycarboxylate ester compounds used in synthesis of the polyester may each be used alone, or may be used in combinations of two or more in selected proportions depending on the purpose (for example, control of the polymer glass transition temperature (Tg), solubility, compatibility with dyes, and stability of dispersion).

The content of the cationic group in the cationic-group-containing polymer is preferably from 0.1 to 5 mmol/g, and more preferably from 0.2 to 3 mmol/g. When the content of the cationic group is too low, the polymer dispersion stability decreases, and when too high, binder compatibility decreases.

The above self-emulsifying polymers including cationic group(s) preferable are polymers including cations of tertiary amine or quaternary ammonium salts, and the particularly preferable are urethane resins like the ones above.

When the above self-emulsifying polymers are used an ink receiving layer of the invention, particularly important is the glass transition temperature thereof. After forming an image by inkjet recording, in order to suppress the occurrence of bleeding with the passage of time, the glass transition temperature of the above self-emulsifying polymer is preferably below 50.degree. C. Further, the self-emulsifying polymer glass transition temperature is more preferably 30.degree. C. or below, and even particularly preferable is a glass transition temperature of 15.degree. C. or below. If the glass transition temperature is 50.degree. C. or above then the dimensional stability (curl) worsens. Here, there is no particular lower limit to the glass transition temperature but, for normal applications it is of the order of −30.degree. C., and if it is lower than this then when preparing the aqueous dispersant the manufacturability can be reduced.

For the mass average of the molecular weight of the self-dispersing polymer used in the invention, usually this is preferably 1000 to 200,000, and 2000 to 50,000 is more preferable. If the molecular weight is less than 100 then there is a tendency that obtaining a stable aqueous dispersant becomes difficult. If the molecular weight exceeds 200,000 then the solubility decreases, the viscosity of the liquid increases and the controlling to a small average particle size the particles of aqueous dispersant tends to become difficult, particularly controlling to 0.05 μm or less. μ

Regarding the amount of the above self-emulsifying polymer to be included in the ink receiving layer of the invention, this is preferably in the range of 0.1 to 30 mass % relative to the total solid contents in the structure of the ink receiving layer, 0.3 to 20 mass % is more preferable and 0.5 to 15 mass % is most favorable. If the above amount included is less than 0.1 mass % then there is insufficient improvement in the bleeding which occurs with the passage of time. On the other hand, if the amount included is over 30 mass % then the proportion of fine particles or binder components gets smaller, and the ink absorption ability on a high quality image recording paper tends to be reduced.

Next, the preparation method of the self-emulsifying polymer of the invention will be explained. The above self-emulsifying polymer is mixed into an aqueous solvent medium, and as required additives are mixed in, and by fragmenting the mixture liquid using a dispersal apparatus, an aqueous dispersion with an average particle size of 0.05 μm or below can be obtained. In order to obtain the aqueous dispersion, various known dispersal apparatuses such as the following can be used: high speed rotary dispersal apparatus, a medium agitation type dispersal apparatus (such as a ball mill, sand mill, bead mill), ultra-sound dispersal apparatus, colloid mill dispersal apparatus, high pressure dispersal apparatus. However, from the perspective of efficiently dispersing the clump-like fine particles, a medium agitation type dispersal apparatus, colloid mill dispersal apparatus or high pressure dispersal apparatus are preferable.

As a high pressure dispersal apparatus (homogenizer) there is the construction described in U.S. Pat. No. 4,533,254, JP-A No. 6-47264 and the like but commercially available apparatuses such as GAULIN HOMOGENIZER (A.P.V Gaulin Inc.), MICROFLUIDIZER (Microfluidex Inc.), ALTIMIZER (Sugino Machine K.K.) can be used. Recently, a high pressure homogenizer equipped with a mechanism to form fine particles in an ultrahigh pressure jet flow as described in U.S. Pat. No. 5,720,551 is particularly effective for emulsifying dispersion of the present invention. DeBEE2000 (Bee International Ltd.) is as an example of an emulsifying apparatus using an ultrahigh pressure jet flow.

For the aqueous medium used in the above dispersing process the following can be used water, organic solvent media, or mixture media thereof. Useable organic solvent media for the dispersing are: alcohols such as methanol, ethanol, n-propanol, i-propanol, and methoxy propanol; ketones such as acetone, methyl ethyl ketone; tetrahydrofuran, acetonitrile, ethyl acetate, toluene.

With the above self-emulsifying polymer, while with the polymer itself a stable emulsion dispersion can be obtained naturally, in order to speed up the emulsifying dispersion and to make it more stable, a small amount of dispersant (surfactant) can be used. For this purpose various surfactants can be used. Preferable examples are anionic surfactants such as fatty acid salts, alkylsulfate ester salts, alkylbenzenesulfonate salts, alkylnaphthalenesulfonate salts, dialkylsulfosuccinate salts, alkylphosphate ester salts, naphthalenesulfonic acid formalin condensates, polyoxyethylene alkylsulfate ester salts and the like. And nonionic surfactants such as polyoxyethylene alkyl ethers, polyoxyethylene alkylaryl ether, polyoxyethylene fatty acid esters, sorbitan fatty acid esters, polyoxyethylenesorbitan fatty acid esters, polyoxyethylene alkyl amines, glycerine fatty acid esters, oxyethylene oxypropylene block copolymers and the like. Further, SURFYNOLS (Air Products & Chemicals), an acetylene-based polyoxyethylene oxide surfactant is also preferably used. Furthermore, amine oxide type ampholytic surfactants such as N,N-dimethyl-N-alkylamine oxide, and the like are also preferable. Further, surfactants listed in JP-A No. 59-157,636, pp. (37) to (38) and Research Disclosure No. 308119 (1989) can be used.

For obtaining stability directly after emulsification, a water-soluble polymer can also be added together with the above-mentioned surfactant. As the water-soluble polymer, polyvinyl alcohols, polyvinylpyrrolidone, polyethylene oxide, polyacrylic acid, polyacrylamide, and copolymers thereof are preferably used. Further, it is also preferable to use naturally occurring water-soluble polymers such as polysaccharides, casein, gelatin and the like.

In the above emulsifying method, when dispersing the above self-emulsifying polymer of the invention in an aqueous medium, particularly important is control of the particle size. When forming an image using an inkjet process, in order to raise the color purity, it is necessary to make the average size of the particles of the self-emulsifying polymer of the above aqueous dispersion small. Specifically, in the ink receiving layer of the invention, it is necessary to make the volume average particle size 0.05 μm or less, and preferably 0.04 μm or less, and 0.03 μm or less if even more preferable.

Generally, the ink receiving layer according to the present invention preferably contains fine particles. The fine particles are preferably inorganic fine particles. Examples of inorganic fine particles include fine particles of silica fine particles, colloidal silica, titanium dioxide, barium sulfate, calcium silicate, zeolite, kaolinite, halloysite, mica, talc, calcium carbonate, magnesium carbonate, calcium sulfate, boehmite, pseudoboehmite. Among these fine particles, silica fine particles are preferable.

The silica fine particle has an extremely high specific surface area, and provides the layer with a higher ink absorption and retention capacity. In addition, the silica has a low refractive index, and thus if dispersed to a suitable particle diameter, provides the ink receiving layer with better transparency, and higher color density and favorable coloring is obtainable. The transparency of ink receiving layer is important from the viewpoint of obtaining a high color density and favorable coloring glossiness not only for applications wherein the transparency is required such as OHP sheets and the like, but also for applications as recording sheets such as photographic glossy papers and the like.

The average primary particles diameter of the inorganic pigment fine particles is preferably 20 nm or less, more preferably 15 nm or less, and particularly preferably 10 nm or less. When the average primary particle size of the particles is 20 nm, the ink-absorbing property can be effectively improved and at the same time, the glossiness of the surface of the ink receiving layer can be enhanced.

In particular with silica fine particles, since the surface has silanol groups, there is easy adhesion between the particles through the hydrogen bonding of the silanol groups, and there is an adhesion effect between the particles through the silanol groups and the water soluble resin. Hence, if the average primary size of the particles is 20 nm or below, then the porosity ratio of the ink receiving layer is high, and a structure with high transparency can be formed, and the ink absorption ability characteristics can be effectively raised.

Silica fine particles are commonly classified roughly into wet method particles and dry method (gas phase process) particles according to the method of manufacture. By the wet method, silica fine particles are mainly produced by generating activated silica by acid decomposition of a silicate, polymerizing to a proper degree the activated silica, and coagulating the resulting polymeric silica to give hydrated silica. Alternatively by the gas phase process, vapor-phase process silica (anhydrous silica) particles are mainly produced by high-temperature gas-phase hydrolysis of a silicon halide (flame hydrolysis process), or by reductively heating and vaporizing quartz and coke in an electric furnace by applying an arc discharge and then oxidizing the vaporized silica with air (arc method). The “vapor-phase process silica” means anhydrous silica fine particles produced by a gas phase process.

The vapor-phase process silica is different in the density of silanol groups on the surface and the presence of voids therein and exhibits different properties from hydrated silica. The vapor-phase process silica is suitable for forming a three-dimensional structure having a higher void percentage. The reason is not clearly understood. In the case of hydrated silica fine particles have a higher density of 5 to 8 silanol groups/nm² on their surface. Thus the silica fine particles tend to coagulate densely. While the vapor phase process silica particles have a lower density of 2 to 3 silanol groups/nm² on their surface. Therefore, vapor-phase process silica seems to cause more scarce, softer coagulations (flocculates), consequently leading to a structure having a higher void percentage. In the present invention, the vapor phase silica (anhydrous silica) obtained by the dry method is preferable, with the surface of the silica fine particles having a density of 2 to 3 silanol groups/nm².

It is preferable that the ink receiving layer of the invention further includes a water soluble resin. Examples of the water-soluble resins used for the ink receiving layer include polyvinyl alcohol resins having a hydroxy group as a hydrophilic constitutional unit polyvinyl alcohol (PVA), cation-modified polyvinyl alcohol, anion-modified polyvinyl alcohol, silanol-modified polyvinyl alcohol, or polyvinylacetal; cellulosic resins [methylcellulose (MC), ethylcellulose (EC), hydroxyethylcellulose (HEC), carboxymethylcellulose (CMC), etc.]; chitins; chitosans; starch; ether bond-containing resins [polyethylene oxide (PEO), polypropylene oxide (PPO), polyethylene glycol (PEG), polyvinyl ether (PVE), etc.]; carbamoyl group-containing resins [polyacrylamide (PAAM), polyvinylpyrrolidone (PVP), etc.]; and the like. In addition, resins having a carboxyl group as the dissociative group, such as polyacrylate salts, maleic acid resins, and alginate salts; gelatins, and the like, are also included. Among the resins, polyvinyl alcohols are particularly preferable.

In order to prevent reduction of layer strength or layer cracking at the time t when the layer is dried, due to too small a content of the water-soluble resin, and prevent reduction of ink absorbing ability caused by blocking of voids by resin due to too high a content of resin, the content of the water-soluble resin in the ink receiving layer is preferably 9 to 40%, more preferably, 12 to 33% by mass with respect to the total solid mass in ink receiving layer. These water-soluble resins and the fine particles described above each may be a single-component substance or a combination of multiple components.

From the viewpoint of preventing cracking of the layer, the number average polymerization degree of the polyvinyl alcohol is preferably 1800 or more, more preferably 2000 or more. From the viewpoint of transparency of the layer, when water soluble resin is used in combination with the silica fine particles, the kind of water soluble resin is important. For combination with anhydrous silica, polyvinyl alcohol resins are preferable as the water-soluble resin. Among them, polyvinyl alcohol resins having a saponification degree of 70 to 99% are preferable.

Examples of the above polyvinyl alcohol include not only polyvinyl alcohol (PVA) but also cation-modified polyvinyl alcohol, anion-modified polyvinyl alcohol, silanol-modified polyvinyl alcohol, and other polyvinyl alcohol derivatives. It is possible to use one kind of polyvinyl alcohol on its own or combinations of two or more kinds of polyvinyl alcohols.

The above polyvinyl alcohol resins contain a hydroxyl group as a structural unit. Hydrogen bonding between the hydroxyl groups and the surface silanol groups on silica fine particles allows the silica fine particles to form a three-dimensional network structure having secondary particles as the network chain units. This three-dimensional network structure thus constructed seems to be the cause of easier development of an ink receiving layer having a porous structure having a higher void percentage. In ink jet recording, the ink receiving layer having a porous structure obtained in this manner absorbs inks rapidly due to the capillary phenomenon, and provides printed dots superior in circularity without ink bleeding.

The ratio (PB ratio:x/y, inorganic pigment fine particles to water soluble resin 1 parts by weight) of the weight of fine particles included (preferably silica fine particles; x) to the weight of water-soluble resin (y) has a great influence on the structure and strength of the ink receiving layer. A larger weight ratio (PB ratio) tends to result in increase in void percentage, pore volume, and surface area (per unit weight). Specifically the PB ratio (x/y) for the ink receiving layer is preferably 1.5 to 10, from the viewpoints of suppressing the decrease in layer strength and prevention of cracking thereof when drying which may be caused due to an excessively high PB value, and preventing a decrease in void percentage and thus in ink absorptive property due to an larger amount of voids blocked more easily due to an excessively low PB ratio.

When transported in a paper transport system of ink jet printers, a stress may be applied to the ink jet recording medium. Accordingly, the ink receiving layer should have sufficiently high layer strength. Also from the viewpoints of preventing cracking, peeling, or the like of the ink receiving layer when the ink jet recording medium are cut into sheets, the ink receiving layer should have sufficiently high layer strength. Considering the above, the PB ratio is preferably 5 or less. On the other hand, from the viewpoint of ensuring the superior ink absorptive property in ink jet printers, the ratio is more preferably 2 or more.

For example, when a coating liquid, containing vapor-phase process silica fine particles, having an average primary particle diameter of 20 nm or less, and a water-soluble resin homogeneously dispersed in an aqueous solution at a PB ratio (x/y) of between 2/1 and 5/1, is applied and dried on a base material, a three-dimensional network structure having the secondary particles of silica fine particles as the network chains is formed. Such a coating liquid easily provides a translucent porous layer having an average void diameter of 30 nm or less, a void percentage of 50 to 80%, a void specific volume of 0.5 ml/g or more, and a specific surface area of 100 m²/g or more.

With respect to the ink receiving layer according to the invention, it is preferable that the layer containing fine particles, a water-soluble resin, and the like, contains additionally a cross-linking agent that allows cross-linking of the water-soluble resin, and thus is a porous layer hardened by the cross-linking reaction between the cross-linking agent and the water-soluble resin.

The above cross-linking agent maybe selected appropriately in relation to the water-soluble resin contained in the ink receiving layer, but boron compounds are preferable, as they allow faster cross-linking reaction. Examples of the boron compounds include borax, borate salts [e.g., orthoborate salts, InBO.sub.3, ScBO.sub.3, YBO.sub.3, LaBO.sub.3, Mg.sub.3 (BO.sub.3).sub.2, and Co.sub.3(BO.sub.3).sub.2], diborate salts [e.g., Mg.sub.2B.sub.2O.sub.5, and Co.sub.2B.sub.2O.sub.5], metaborate salts [e.g., LiBO.sub.2, Ca(BO.sub.2).sub.2, NaBO.sub.2, and KBO.sub.2], tetraborate salts [e.g., Na.sub.2B.sub.4O.sub.7.10H.sub.2O], pentaborate salts [e.g., KB.sub.5O.sub.8.4H.sub.2O, Ca.sub.2B.sub.6O.sub.11.7H.sub.2O, and CsB.sub.5O.sub.5], and the like. Among them, borax, boric acid and borates are preferable since they are able to promptly cause a cross-linking reaction. Particularly, boric acid is preferable, and the combination of polyvinyl alcohol and boric acid is most preferred.

The above cross-linking agent is preferably included to an amount of 0.05 to 0.50 parts by weight relative to 1 part by weight of the water soluble resin. More preferable is an inclusion amount of 0.08 to 0.30 parts by weight. If the amount of inclusion of the cross-linking agent is within the above ranges then the water soluble resin can be effectively be cross-linked and development of cracks and the like can be prevented.

When gelatin and the like are used as a water-soluble resin in the invention, other compounds than the boron compounds, as described below, can be used for the cross-linking agent of the water-soluble resin.

Examples of such cross-linking agents include: aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium salt; active vinyl compounds such as divinyl sulfonic acid, 1,3-vinylsulfonyl-2-propanol, N,N′-ethylenebis(vinylsulfonylacetamide) and 1,3,5-triacryloyl-hexahydro-S-triazine; N-methylol compounds such as dimethylolurea and methylol dimethylhydantoin; melamine resin such as methylolmelamine and alkylated methylolmelamine; epoxy resins;

Isocyanate compounds such as 1,6-hexamethylenediisocyanate; aciridine compounds such as those described in U.S. Pat. No. 3,017,280 and No. 2,983,611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid dihydrazide; and low molecular compounds or polymers containing at least two oxazoline groups. The cross-linking agent may be used alone, or two or more cross-linking agents may be combined.

The cross-linking agent can be supplied in a number of ways, such as when forming the ink receiving layer, the above cross-linking agents can be added to the ink receiving layer coating liquid and/or a coating liquid which is used for forming a layer adjacent and contacting the ink receiving layer. Or a coating liquid which includes the cross-linking agent can be applied in advance onto the base material and the ink receiving layer coating liquid can be coated. Or, a solution of the cross-linking agent can be over-coated onto a coating of an ink receiving layer coating liquid after it has dried. From the perspective of manufacturing efficiency, it is preferable that the cross-linking agent is added to the ink receiving layer coating liquid or a coating liquid for forming an adjacent contacting layer, and the cross-linking agent is supplied at the same time as forming the ink receiving layer. In particular, from the perspective of raising the print image density and glossiness of images, it is preferable to include the cross-linking agent in the coating liquid for the ink receiving layer. It is preferable that the concentration of the cross-linking agent in the ink receiving liquid coating layer is between 0.05 and 10% by mass, and more preferable between 0.1 and 7% by mass.

The cross-linking agent may be added as follows, where a boron compound is used as the cross-linking agent as an example. When the ink receiving layer is a hardened coating layer of coating solution (coating solution 1), the layer is cured by cross-linking by applying a basic solution (coating solution 2) having a pH value of 7.1 or more on the coating layer, either (1) at the same time for forming the coating layer by applying coating solution 1; or (2) during the drying step of the coating layer formed by applying coating solution 1 and also before the coating layer exhibits a decrease in the rate of drying. The boron compound acting as the cross-linking agent may be contained in either coating solution 1 or coating solution 2, or alternatively maybe contained in both the coating solution 1 and coating solution 2.

In order to raise the water resistance and resistance to the occurrence of bleeding with the passage in time of formed images, it is preferable that a mordant is added to the ink receiving layer. For the mordant can be used an inorganic mordant such as a cationic polymer (cationic mordant), or a inorganic mordant such as a water soluble metallic compound. Among these water soluble multi-valent metal salts are preferable.

For the water soluble multivalent metal salt compounds of the invention water soluble salts of the following metals can be used: calcium, barium, manganese, copper, cobalt, nickel, aluminum, iron, zinc, zirconium, chromium, magnesium, tungsten, molybdenum.

More specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, copper II chloride, copper II ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminum sulfite, aluminum thiosulfate, polychlorinated aluminum, aluminium nitrate nonahydrate, aluminium chloride hexahydrate, iron I bromide, iron I chloride, iron II chloride, iron II sulfate, iron II sulfate, zinc bromide, zinc chloride, zinc nitrate hexahydrate, zinc sulfate, zirconyl acetate, zirconium chloride, zirconium oxychloride octahydrate, zirconium hydroxychoride, chromium acetate, chromium sulfate, manganese sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, and the like.

For the above soluble multivalent metal salt compounds, it is preferable to select one or more from soluble aluminum compounds, zirconium compounds or titanium compounds.

As the above aluminum compounds, for example, inorganic salts such as aluminum chloride, or hydrates thereof, aluminum sulfate or hydrates thereof, and aluminum alum are known. Further more, there are inorganic based aluminum cationic polymers such as basic poly hydroxylated aluminum compounds. Basic poly hydroxylated aluminum compounds are preferable.

The above basic poly hydroxylated aluminum compounds, are water soluble polyhydroxylated aluminum compounds stably including multi-nucleated condensate ions, such as [Al.sub.6(OH).sub.15].sup.3+, [Al.sub.8(OH).sub.20].sup.4+, [Al.sub.13(OH).sub.34].sup.5+, [Al.sub.21(OH).sub.60].sup.3+, of basic polymers basic polymers. They have as their main components the compounds show in the formula (1), (2) and (3) below.

[Al.sub.2(OH).sub.nCl.sub.6-n].sub m (1)

[Al(OH).sub.3].sub.nAlCl.sub.3 (2)

Al.sub.n(OH).sub.mCl.sub.(3 n-m)0<m<3n (3)

These compounds can be easily obtained and are placed on the market by Taki Chemical Co. Ltd. as polychlorinated aluminum (PAC) as water treatment agents, by Asada Kagaku Co. Ltd. as polyhydrated aluminium (Paho), also by Rikengreen Co. Ltd., and other manufacturers for the same purpose. In the invention is is suitable to use the commercially available products directly, but since there are materials which have inappropriately low pH values, in these cases it is possible to use by suitably adjusting the pH.

As the zirconium compounds, there are no particularly limitations and various compounds can be used. However, examples which can be given are compounds of zirconyl acetate, zirconium choride, zirconium oxychloride, zirconium hydroxychloride, zirconyl nitrate, basic zirconium carbonate, zirconium hydroxide, zirconium ammonium carbonate, zirconium potassium carbonate, zirconium sulphate, zirconium fluoride. Zirconyl acetate is particularly preferable.

As the above titanium compounds, there are no particular limitations and various compounds can be used, for example titanium chloride, and titanium sulfate.

Since the pH of some of these compounds is inappropriately low, the pH can be adjusted to an appropriate value. In the invention, as a guide, the solubility in water at normal temperature and pressure should be greater than 1%, relative to the water by mass.

In the invention the amount of the above water soluble multi-valent metal salt compounds included in the ink receiving layer is preferably 0.1 to 10% by mass relative to the fine particles, and more preferably 1 to 5% by mass.

One of the above water soluble multi-valent metal salt compounds can be used alone, but preferably two or more of them are used in combinations.

By having the above mordants at least in the upper portion of the ink receiving layer, due to the interaction of the anionic dyes used as the coloring materials in the inkjet liquid inks, the coloring material can be stabilized and the water resistance and tendency to bleed after a lapse of time can be improved.

For the above cationic mordants, polymers mordants with cationic groups of primary, secondary or tertiary amino groups, or quaternary ammonium salt groups are well suited but non-polymer mordants which are cationic also can be used.

For the above polymer mordants, preferable are single polymers of monomers with primary, secondary or tertiary amino groups or salts thereof, or quaternary ammonium salt groups (referred to below as mordant monomers), and copolymers or condensation polymers of the mordant monomers with other monomers (referred to below as non-mordant monomers). Also, these polymer mordants can be used in the form of either water soluble polymers, or water dispersible latex particles.

Examples of the above mordant monomer include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;

Trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate;

N,N-dimethylaminoethyl(meth)acrylate, N,N-diethylaminoethyl(meth)acrylate, N,N-dimethylaminopropyl (meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide, or N,N-diethylaminopropyl(meth)acrylamide; and sulfonates, alkyl sulfonates, acetates, or alkyl carboxylates derived from the quaternary compounds by replacement of the anion.

Specific examples of such compounds include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride;

N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy) ethyl ammonium bromide, trimethyl-3-(acryloylamino)propylammonium bromide, trimethyl-2-(methacryloyloxy)ethylammonium sulfonate, and trimethyl-3-(acryloylamino) propylammonium acetate. Examples of other copolymerizable monomers include N-vinylimidazole and N-vinyl-2-methylimidazole.

Further, allylamine, diallyamine, and derivatives and salts thereof may also be used. Examples of these compounds include allylamine, allylamine hydrochloride, allylamine acetate, allylamine sulfate, diallyamine, diallyamine hydrochloride, diallyamine acetate, diallyamine sulfate, diallylmethylamine and the salts thereof (e.g., hydrochloride, acetate, and sulfate salts, and the like), diallylethylamine and the salts thereof (e.g., hydrochloride, acetate, and sulfate salts, and the like), diallyldimethylammonium salts (counter anions thereof including chloride, acetate, and sulfate ions), and the like. These allylamine and diallyamine derivatives are less polymerizable in the amine form, and thus are commonly polymerized in the salt form and desalted thereafter if necessary.

Additionally, polymerization units of N-vinylacetamide and N-vinylformamide can be used, to give vinylamine units by hydrolyzation after polymerization, or salts thereof can be used.

The term “a non-mordant monomer” refers to a monomer that does not have a basic or cationic moiety, such as a primary, secondary or tertiary amino group, a salt thereof, or a quaternary ammonium salt group, and exhibits no or substantially little interaction with dye in inkjet ink.

Examples of non-mordant monomers include alkyl ester (meth)acrylates; cycloalkyl ester (meth)acrylates such as cyclohexyl (meth)acrylate; aryl ester (meth)acrylates such as phenyl (meth)acrylate; aralkyl ester(meth)acrylates such as benzyl (meth)acrylate; aromatic vinyl compounds such as styrene, vinyltoluene and .alpha.-methylstyrene; vinyl esters such as vinyl acetate, vinyl propionate and vinyl versatate; allyl esters such as allyl acetate; halogen-containing monomers such as vinylidene chloride and vinyl chloride; vinyl cyanides such as (meth)acrylonitrile; and olefins such as ethylene and propylene.

The above alkyl ester (meth)acrylates preferably have 1 to 18 carbon atoms in the alkyl moiety. Examples of such alkyl ester (meth)acrylates include methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, hexyl (meth)acrylate, octyl (meth)acrylate, 2-ethylhexyl (meth)acrylate, lauryl (meth)acrylate, and stearyl (meth)acrylate. Particularly preferred are methyl acrylate, ethyl acrylate, methyl methacrylate, ethyl methacrylate, and hydroxyethyl methacrylate. One kind of non-mordant monomer may be used alone or two or more kinds of non-mordant monomers may be used in combination.

Preferred examples of the polymeric mordant also include poly diallyldimethyl ammonium chloride, poly methacryloyloxyethyl-.beta.-hydroxyethyldimethylammonium chloride, poly ethyleneimine, polyallylamine and modified derivatives thereof, polyallylamine hydrochloride, polyamide-polyamine resins, cationized starch, dicyandiamide formaldehyde condensates, dimethyl-2-hydroxypropylammonium salt polymers, polyamidine, polyvinylamine, and an acrylic cationic emulsion of an acryl silicone latex described in JP-A Nos. 10264511, 2000-43409, 2000-343811 and 2002-120452 (“AQUABRID ASi-781, ASi784, ASi-578 and ASi-903 (Trade Name) manufactured by Daicel Chem. Ind. Ltd.).

Regarding the molecular weights of the above mordants, the weight average molecular weight is preferably 2000 to 300,000. If the molecular weight is in this range then the water resistance and the tendency to develop bleeding with the lapse of time can be further improved.

The ink receiving layer may further contain the following components if necessary. Namely, for the purpose of suppressing the deterioration of the ink colorant, anti-fading agents such as various ultraviolet absorbers, antioxidants and singlet oxygen quenchers may be contained.

Examples of the ultraviolet absorbers include cinnamic acid derivatives, benzophenone derivative and benzotriazolyl phenol derivatives. Specific examples include .alpha.-cyano-phenylc innamic acid butyl, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and phenols in which at least one or more of the second place and/or the sixth place is substituted by a branching alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers as described in JP-A Nos. 47-10537, 58-111942, 58-212844, 59-19945, 59-46646, 59-109055 and 63-53544, Japanese Patent Application (JP-B) Nos. 36-10466, 42-26187, 48-30492, 48-31255, 48-41572 and 48-54965, 50-10726, U.S. Pat. No. 2,719,086, U.S. Pat. No. 3,707,375, U.S. Pat. No. 3,754,919 and U.S. Pat. No. 4,220,711.

An optical brightening agent can be also used as an ultraviolet absorber, and specific examples include a coumalin based optical brightening agent. Specific examples are described in JP-B Nos. 45-4699 and 54-5324 or the like.

Examples of the antioxidants are described in EP 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536;

JP-A Nos. 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. No. 4,814,262 and U.S. Pat. No. 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl) propane, 1,1-bis(4-hydroxyphenyl)-2-ethylhexane, 2-methy-4-methoxy-diphenylamine, 1-methyl-2-phenyl indole.

These anti-fading agents can be used singly or in combinations of two or more. The anti-fading agents can be dissolved in water, dispersed, emulsified, or they can be included within microcapsules. The amount of the anti-fading agents added is preferably 0.01 to 10% by mass, relative to the total ink receiving layer coating liquid.

In order to prevent curl, it is preferable to include organic solvents with a high boiling point in the ink receiving layer. For the above high boiling point organic solvents water soluble ones are preferable. As water soluble organic solvents with high boiling points the following alcohols are examples: ethylene glycol, propylene glycol, diethylene glycol, triethylene glycol, glycerin, diethylene glycol monobutylether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanolamine, polyethylene glycol (average molecular weight of less than 400). Diethylene glycol monobutylether (DEGMBE) is preferable.

The amount of the above high boiling point organic solvents used in the coating liquid for the ink receiving layer is preferably 0.05 to 1% by mass, and particularly favorable is 0.1 to 0.6% by mass. Also, for the purpose of increasing the dispersability of the inorganic pigment fine particles, each of the types of inorganic salts can have the pH adjusted with the inclusion of acids or alkalis. Further, in order to suppress the generation of on the surface of friction charging and exfoliation charging, conductive metallic compound fine particles, and matting agents, for reducing the surface friction, can be included.

The base material may be either transparent made of a transparent material such as plastic, or opaque made of an opaque material such as paper. Especially, a transparent base material or a glossy opaque base material is preferred to make the best use of the transparency of the ink receiving layer.

The base material is preferably made from a transparent material able to endure radiant heat when used in OHPs and backlight displays. Examples of the material include polyesters such as polyethylene terephthalate (PET); polysulfone, polyphenylene oxide, polyimide, polycarbonate and polyamide. The polyesters are preferable among them, and especially, polyethylene terephthalate is preferable. The thickness of the transparent base material, though it is not particularly limited, is preferably 50 to 200 μm in view of handling.

The glossy opaque base material preferably has a glossiness degree of 40% or more on the surface to the ink receiving layer. This glossiness degree is a value determined according to the method described in JIS P-8142 (paper and a paperboard 75 degree method for examining specular glossiness degree).

Examples of such base materials include art papers, coat papers, cast coat papers, baryta papers or other paper materials used as a base material for a silver salt photography or the like; polyesters such as polyethylene terephthalate (PET), cellulose esters such as nitrocellulose, cellulose acetate and cellulose acetate butyrate, opaque high glossiness films which are constituted by incorporating white pigment or the like in plastic films such as polysulfone, polyphenylene oxide, polyimide, polycarbonate and polyamide (a surface calendar treatment maybe performed); or, base materials in which a coating layer made of polyolefin which either does or does not contain a white pigment is formed on the surface of a high glossiness film containing the various paper materials, transparent base materials or white pigment or the like. Also, white pigment-containing foam polyester film (for instance, a foam PET which contains the polyolefin fine particles, and contains voids formed by drawing out) is preferable. Further, a resin coated paper for silver halide salt photographic use is suitable.

The thickness of the opaque base material, though it is not particularly limited, is preferably 50 to 300 μm in view of handling. One treated by corona discharge treatment, glow discharge treatment, flame treatment or ultraviolet radiation treatment or the like may be used for the surface of the base material, so as to improve wetting and adhesion properties.

Hereinafter described is a base paper, such as resin coated paper, used for the paper material. The base paper is mainly made of wood pulp, and is made by using a synthetic pulp, such as polypropylene, in addition to the wood pulp if necessary, or a synthetic fiber such as nylon or polyester. LBKP, LBSP, NBKP, NBSP, LDP, NDP, LUKP and NUKP can be used as the wood pulp. It is preferable to use more LBKP, NBSP, LBSP, NDP and LDP which contain a lot of short fibers. The ratio of LBSP and/or LDP is preferable in the range between 10% by mass and 70% by mass.

A chemical pulp with few impurities (sulfate pulp and sulfite pulp) is preferably used as the pulp, and a pulp in which whiteness is improved by bleaching, is useful. Sizing agents such as higher fatty acid and alkyl ketene dimer, white pigments such as calcium carbonate, talc and titanium oxide, paper reinforcing agents such as starch, polyacrylamide and polyvinyl alcohol, optical brightening agents, water retention agents such as polyethylene glycols, dispersing agents, and softening agents such as a quaternary ammonium can be appropriately added to the base paper.

The freeness of pulp used for papermaking is preferably 200 to 500 ml as stipulated in CSF. The sum of 24 mesh remainder portions and 42 mesh remainder portions is preferably 30 to 70% by mass as stipulated in JIS P-8207. 4 mesh remainder portion is preferably 20% by mass.

The basis weight of the base paper is preferably 30 to 250 g, and more preferably 50 to 200 g. The thickness of the base paper is preferably 40 to 250 μm. High smoothness can be imparted to the base paper by calendar treatment at the making paper step or after paper making. The density of the base paper is generally 0.7 to 1.2 g/m² (JIS P-8118). In addition, the strength of the base paper is preferably 20 to 200 g under the conditions of JIS P-8143.

A surface size agent may be coated on the surface of the base paper, and a size agent which is the same as size which can be added to the base paper can be used as the surface size agent. It is preferable that the pH of the base paper is 5 to 9 when measured by a hot water extraction method provided by JIS P-8113.

In general, the both front and back surfaces of the base paper can be coated with polyethylene. Main examples of polyethylenes include low density polyethylene (LDPE) and/or high density polyethylene (HDPE) but others such as LLDPE and polypropylene can be also used in part.

Especially, in the polyethylene layer on the side on which the ink receiving layer is formed, it is preferable that rutile type or anatase type titanium oxide, an optical brightening agent or ultramarine blue pigment are added to polyethylene, and thereby the degree of opaqueness, whiteness and color are improved, as is widely performed for printing papers for photographs. Herein, the content of titanium oxide is preferably about 3 to 20% by mass, and more preferably 4 to 13% by mass to polyethylene. The thickness of the polyethylene layer is not limited to a particular thickness, and more preferably 10 to 50 μm. Further, an undercoat layer can be formed to give adhesion of the ink receiving layer on the polyethylene layer. Water polyester, gelatin, and PVA are preferably used as the undercoat layer. The thickness of the undercoat layer is preferably 0.01 to 5 μm.

A polyethylene coated paper sheet may be used as glossy paper, or when polyethylene is coated on the base paper sheet by melt-extrusion a matte surface or silk finish surface may be formed by applying an embossing treatment, as obtainable in usual photographic printing paper sheets.

The base material may have a back coat layer, which can contain white pigments, water soluble binders and other components as additives. Examples of the white pigment contained in the back coat layer include inorganic white pigments such as calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resin and melamine resin.

Examples of the aqueous binders used for the back coat layer include water soluble polymers such as styrene/maleic acid copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinyl pyrrolidone; and water dispersible polymers such as styrene-butadiene latex and acrylic emulsion. Other components in the back coat layer include defoaming agents, foaming suppressing agents, dyes, optical brighteners, preservatives and water-proofing agents.

The ink receiving layer of the inkjet recording paper of the invention is preferably formed by a so-called “Wet on Wet” method of cross-linking curing of a coating layer by: application of a coating layer containing at least an aqueous dispersion of the self-emulsifying polymer of the invention and a water soluble resin (the first coating liquid) onto a surface of the base material; adding a cross-linking agent to the coating liquid (first coating liquid) and/or to a basic liquid (the second coating liquid), having a pH value of 7.1 or above; and applying the second coating liquid onto the coating layer formed by the first coating liquid, at either (1) the same time as forming the coating layer by applying coating liquid A, or (2) during the drying of the coating layer formed by applying coating liquid A and before the coating layer exhibits a decrease in the drying rate.

The above cross-linking agent for cross-linking of the water soluble resin is preferably added to one or both of the above first coating liquid or second coating liquid. Forming cross-linking of the ink receiving layer in this way by applying the basic liquid (second coating liquid) to the first coating liquid at the above times of (1) the same time, or (2) during drying is particularly preferable to improve the appearance, from the perspective of the ink absorption ability and prevention of cracks in the film, as well as cissing defects.

Here, the aqueous dispersion material of the self-emulsifying polymer of the invention in the ink receiving layer is added to at least one of the first coating liquid and/or the second coating liquid (basic liquid). However, from the perspective of sufficiently mixing with the fine particles and the water soluble resin of the first coating liquid in order to effectively prevent the occurrence of bleeding with lapse of time, an embodiment in which the aqueous dispersion material of the self-emulsifying polymer is included in the first coating liquid (the coating liquid including the fine particles and water soluble resin) is preferable. In this case, it is not always necessary that all of the aqueous dispersion material of the above self-emulsifying polymer is included in the first coating liquid, and it is also effective to include at least a portion of the aqueous dispersion material of the above self-emulsifying polymer of the invention in the second coating liquid. By so doing the occurrence of bleeding with lapse of time can be effectively prevented. An embodiment is also preferable in which at least a portion of the aqueous dispersion material of the self-emulsifying polymer of the invention is included in both of the first and second coating liquids.

The mordant is included such that a thickness from the surface of the ink receiving layer of the portion containing the mordant accounts for preferably 10 to 60% of the total thickness of the ink receiving layer. For example, either of these methods can be selected: (1) forming a coating layer containing the fine particles and the water-soluble resin or cross-linking agent, followed by coating a mordant-containing solution thereon; or (2) multi-coating, by applying the coating liquid containing the fine particles and water-soluble resin or cross-linking agent, at the same time as coating the mordant-containing solution. Also, inorganic fine particles, water-soluble resin and cross-linking agent may be added to the mordant-containing solution. Forming by the above methods is preferable since significant amount of mordant is then present in a specific portion of the ink receiving layer, and so the ink coloring material of the inkjet can be sufficiently mordanted, and the color density, the tendency to bleed with the lapse in time, glossiness of the printed areas, the water resistance of text and images after printing, and the resistance to ozone can be further improved. A portion of the mordant can contained in a layer provided at first on the base material. In this case the mordant applied later can be the same mordant or a different mordant.

The first coating liquid, which contains inorganic pigment fine particles, water soluble resin and a boron compound (cross-linking agent), may be prepared as below.

Silica fine particles with a uniform average particle diameter of 20 nm or below can be added to water (for example, to a silica fine particle concentration in water of 10 to 20% by mass), dispersing the fine particles using a high speed rotational wet-type colloid mill (such as trade name: Clearmix, manufactured by M Technique Co., Ltd.) at a high speed rotation of 10,000 rpm (preferably, at 5,000 to 20,000 rpm) for 20 minutes (preferably, for 10 to 30 minutes), then adding a boron compound (for example at a rate of 0.5 to 20%, relative to the silica by mass), dispersal under the same conditions as above, adding an aqueous polyvinyl alcohol (PVA) solution (to make the PVA concentration become about ⅓ of the concentration of the silica), and again dispersing under the same conditions as described above. The thus obtained coating liquid is in the state of a sol, and a porous ink receiving layer having a three-dimensional network structure can be formed by applying the solution onto the base material by the method described below. Where necessary, pH adjusting agents, a dispersants, surfactants, anti-foaming agents, anti-static agents and the like can be added to the above first liquid.

Dispersing machine used for the dispersion can be any conventional dispersing machine, such as a highspeed rotational dispersing machine, medium agitating-type dispersing machine (such as a ball mill and a sand mill), ultrasonic dispersing machine, colloid mill dispersing machine or high pressure dispersing machine. However, the medium agitating-type dispersing machine, colloid mill dispersing machine and high pressure dispersing machine are preferable for efficiently dispersing coagulates of the fine particles.

Water, organic solvents and mixed solvents thereof may be used as the solvent in each step. Examples of the organic solvent used for preparing a coating solution include alcohols such as methanol, ethanol, n-propanol, i-propanol and methoxypropanol, ketones such as acetone and methylethyl ketone, tetrahydrofuran, acetonitrile, ethyl acetate and toluene.

The surfactant included in the second coating liquid (basic liquid) can, for example, be adjusted as set out below. That is, mordant (for example 0.1 to 5.0% by mass) and surfactants (for example to a total amount of 0.01 to 1.0% by mass) and, where required, cross-linking agent (0 to 5.0% by mass) can be added to ion exchange water and agitated sufficiently. The pH of the second coating liquid is preferably more than 8.0, and by using pH adjusters such as aqueous ammonia, sodium hydroxide, potassium hydroxide, amine group containing compounds (such as ethylene, ethanol amine, diethanol amine, polyallylamine) the pH can be set to 8.0 or above.

The first coating solution (coating solution of the ink receiving layer) can be coated by a known method, such as using an extrusion die coater, an air doctor coater, a blade coater, a rod coater, a knife coater, a squeeze coater, a reverse roll coater, or a bar coater.

While the second coating solution (basic coating solution) is applied on the coating layer simultaneously with or after applying the first coating solution (coating solution for ink receiving layer), the second coating solution may be applied before the coating layer exhibits a fall in the rate period of drying. In other words, the ink receiving layer is favorably formed by providing the basic coating solution before the coating layer exhibits falling rate of drying after applying the first coating solution for the ink receiving layer. A mordant may be added to the second coating solution.

The term “before the coating layer exhibits a falling rate of drying” usually means a process within several minutes from immediately after applying the coating solution of the ink receiving layer. During this period the content of the solvent (dispersing medium) in the applied coating solution decreases in proportion to the lapse of time (a constant rate period of drying). The time lapse exhibiting “constant rate period of drying” is described, for example, in Kagaku Kogaku Binran (Chemical Engineering Handbook), pp. 707-712, Maruzen Co. Ltd., 25 Oct. 1980.

The period in which the coating layer is dried until it exhibits a falling rate of drying after applying coating solution A, is usually, at 50 to 180.degree. C., for 0.5 to 10 minutes (preferably, 0.5 to 5 minutes). While this drying time differs depending on the amount of coating, the aforementioned range is usually appropriate.

Examples of the method for applying the coating solution before the first coating layer exhibits a falling rate period of drying include (1) further coating the second coating solution on the coating layer, (2) spraying the second coating solution, and (3) dipping the base material on which the coating layer has been disposed in the second coating solution.

The method used for applying coating solution 2 in the above method (1) includes known application method using, for example, a curtain flow coater, an extrusion die coater, an air doctor coater, a blade coater, a rod coater, a knife coater, a squeeze coater, a reverse roll coater and a bar coater. The extrusion die coater, curtain flow coater or bar coater is preferably used to prevent the coater from contacting with the already formed first coating layer.

The coating amount of the second coating liquid is generally 5 to 50 g/m², and preferably 10 to 30 g/m².

After application of the second coating liquid, generally drying and curing is carried out at 40 to 180.degree. C. for 0.5 to 30 minutes. Heating at a temperature of 40 to 150.degree. C. for 1 to 20 minutes is preferable. For example, when borax or boric acid is included in the first coating liquid as a cross-linking agent, then carrying out heating to a temperature of 60 to 100.degree. C. for 5 to 20 minutes is preferable.

When the basic solution (coating solution 2) is applied simultaneously with applying the coating solution (coating solution 1) for the ink receiving layer, coating solutions 1 and 2 are simultaneously provided on the base material so that coating solution 1 contacts the base material (multi-layer coating), and then the solutions are dried to thereby form the ink receiving layer.

Coating methods using, for example, an extrusion die coater or a curtain flow coater may be employed for simultaneous application (multilayer coating). When the coated layers are dried after the simultaneous coating, these layers are usually dried by heating at 40 to 150.degree. C. for 0.5 to 10 minutes, and preferably by heating at 40 to 100.degree. C. for 0.5 to 5 minutes.

When the coating solutions are simultaneously applied (multi-layer coating) using, for example, an extrusion die coater, the simultaneously supplied two coating solutions are laminated at near the outlet of the extrusion die coater, or immediately before the solutions are transferred onto the base material, and are laminated on the base material to make a dual layer. Since the two layers of the coating solutions laminate before application onto the base material, they tend to undertake cross-linking at the interface between the two solutions while the solutions are transferred onto the base material. The supplied two solutions readily become viscous, when mixed with each other in the vicinity of an outlet of the extrusion die coater, and occasionally cause trouble in the coating operation. Accordingly, it is preferable to simultaneously arrange triple layers by presenting a barrier layer solution (intermediate layer solution) between the solution 1 and solution 2, at the same time as applying of the coating solutions 1 and 2.

The barrier-layer solution can be selected without particularly limitations, and examples thereof include an aqueous solution containing a trace amount of water-soluble resin, water, and the like. The water-soluble resins are used considering the coating property of the solution, for example, for increasing the viscosity of the solution, and examples thereof are polymers including cellulosic resins (e.g., hydroxypropylmethylcellulose, methylcellulose, hydroxyethylmethyl cellulose, and the like), polyvinylpyrrolidone, gelatin, and the like. The barrier-layer solution may also contain a mordant.

After forming on the base material, the ink receiving layer maybe subjected to calendering by passing through roll nips under heat and pressure, for example, by using a super calender or gloss calender, or the like, for improvement in the surface smoothness, glossiness, transparency, and strength of the coated film. However, because calendering sometimes causes decrease in void ratio (i.e., decrease in ink absorptive property), it is necessary carryout calendering under conditions set to reduce the decrease in void percentage.

The roll temperature during this calendar processing is preferably 30 to 150.degree. C. more preferably 40 to 100.degree. C., and the linear pressure between rolls during calendering is preferably 50 to 400 kg/cm and more preferably 100 to 200 kg/cm.

The thickness of the ink receiving layer needs to be determined, in the case of inkjet recording, based on the void percentage of the layer, as the layer should have a sufficient absorption capacity allowing absorption of all droplets. For example, if the ink quantity is 8 nl/mm² and the void percentage is 60%, a film having a thickness of about 15 μm or more is required. Considering the above, ink receiving layer for inkjet recording preferably has a thickness of 10 to 50 μm.

In addition, the median diameter of the pores in the ink receiving layer is preferably 0.005 to 0.030 μm, and more preferably 0.01 to 0.025 μm. The void percentage and the pore median size may be determined by using a mercury porosimeter (trade name: “Poresizer 9320-PC2”, manufactured by Shimadzu Corporation).

The ink receiving layer is preferably higher in transparency, and the haze value, an indicator of transparency, of the ink receiving layer formed on a transparent film base material is preferably 30% or less and more preferably 20% or less. The haze value may be determined by using a hazemeter (trade name: HGM-2DP, manufactured by Suga Test Instrument Co., Ltd.).

Various changes and modifications are possible in the present invention and may be understood to be within the present invention.

1. An inkjet recording medium having a base material, first and second resin coat layers on both surfaces of said base material, and an ink receiving layer on said second resin coat layer, said inkjet recording medium comprising:
end faces in a width direction of said inkjet recording medium, said end faces being slit by a slitter, each of said end faces having a cross section in which at least one of said second resin coat layer and said ink receiving layer or said base material projects outward relative to said first resin coat layer.

2. The inkjet recording medium of claim 1, wherein said end faces comprise side edges extending parallel to a transport direction in printing.

3. The inkjet recording medium of claim 1, wherein said ink receiving layer contains water soluble resin and fine particles, and a ratio of weight of said fine particles to said water soluble resin is at least 1.5 and up to 10.

4. The inkjet recording medium of claim 1, wherein said ink receiving layer has a thickness of 10 to 50 micrometers.

5. The inkjet recording medium of claim 1, wherein said ink receiving layer comprises a porous layer having a median pore diameter of 0.005 to 0.030 micrometers.

6. A method of manufacturing an inkjet recording medium comprising the steps of:
producing a web by firstly applying first and second resin coat layer on both surfaces of a base material, and subsequently applying an ink receiving layer on said second resin coat layer; and
slitting said web in a width direction thereof by using a slitter while transporting said web in one direction with said ink receiving layer facing downward,
wherein said slitter has an upper rotary blade with a sharp cutting edge for press-cutting said web in the width direction and a lower rotary blade with a support for supporting said web, and slits said web in such a manner that an end face in the width direction of said web has a cross section in which at least one of said second resin coat layer and said ink receiving layer or said base material projects outward relative to said first resin coat layer.

7. The method of claim 6, further comprising the step of transecting said web into predetermined length sheets in such a manner that end faces being slit by said slitter comprise side edges extending parallel to a transport direction in printing.

8. The method of claim 6, wherein said upper rotary blade has a blade angle of 30 degrees, and said lower rotary blade has a blade angle of 90 degrees.

9. The method of claim 6, wherein said upper rotary blade has a blade angle of 30 degrees, and said lower rotary blade has a blade angle of 30 degrees.

10. The method of claim 6, wherein said upper rotary blade has a blade angle of 60 degrees, and said lower rotary blade has a blade angle of 90 degrees.

11. The method of claim 6, wherein said ink receiving layer contains water soluble resin and fine particles, and a ratio of weight of said fine particles to said water soluble resin is at least 1.5 and up to 10.

12. The method of claim 6, wherein said ink receiving layer has a thickness of 10 to 50 micrometers.

13. The method of claim 6, wherein said ink receiving layer comprises a porous layer having a median pore diameter of 0.005 to 0.030 micrometers.
